(19) United States
(12) Patent Application Publication
(10) Pub. No.: US 2006/0037451 A1
(43) Pub. Date: Feb. 23, 2006

(54) Circular saw with blade guide

(75) Inventor: Kauko Rautio, Mantyharju (FI)

Correspondence Address: BIRCH STEWART KOLASCH & BIRCH, PO BOX 747, FALLS CHURCH, VA, 22040-0747, US

(73) Assignee: VEISTO OY, Mantyharju (FI)

(21) Appl. No.: 11/188,629

(22) Filed: Jul. 26, 2005

(30) Foreign Application Priority Data
Aug. 19, 2004 (FI) 20041094

(51) Int. Cl. B27B 1/00; B23D 15/00

(52) U.S. Cl. 83/435.11; 83/828; 144/370

(57) ABSTRACT

A circular saw for sawing wood pieces, which circular saw has blade guides (5, 21) which are fastened to fastening arms (4, 22), and in which the fastening arm (4, 22) of the blade guides (5, 21) is fastened concentrically with a drive axle (6, 23) of the saw blade (1) pivotedly so that the fastening arm is able to turn around the drive axle (6, 23), and the blade guides are fastened to the fastening arm (4, 22) pivotedly with a fastening bearing (10, 24) so that they are able to turn around the fastening bearing (10, 24).

This invention relates to a circular saw which has blade guides according to the preamble of claim 1.

When sawing wood material, such as logs, with a circular saw or similar, axial (blade fastening axle) forces are caused by blade forces, wood characteristics and wood movements. A thin blade in the axial direction is usually weak and thus also susceptible for deflecting. The deflection and vibration of the blade causes, in addition to dimensional variance and weakening of surface quality, sometimes also blade damages, if the deflections and vibrations are extremely great. For this reason, blades have many times been supported with blade guides which aim at preventing the axial movements of the blade by supporting it from the sides (from a blade frame) with suitable guide pieces.

Known solutions, such as the published patent application FI-79479, describe a circular saw which has circular blades movable in relation to each other, which blades have been arranged side by side on the same threaded axle and which has blade guides which actuate on the outer surfaces of the circular blades. The blade-guide arms holding the blade guides are fastened to striking rods which are not coaxial with the blade axle, that is, blades have been fastened to a different axle than the blade guides. Because of this, the guides cannot always be positioned to the correct distance from the sawing piece in order to have the best possible support for the blade. In addition, the blade guides require their own striking rods for moving them.

The object of this invention is to eliminate or reduce above-mentioned problems which arise when sawing wood pieces of different sizes with a sawing machine. However, sawing is usually performed when the diameter of the circular blade remains fixed. In some cases, such as in the case of a biaxial circular saw, when sawing smaller pieces of wood, only the outer circle of the blade is used, and with larger pieces, the wood extends closer to the axle centre line. In order to gain total advantage of the blade guide, it should be in the correct distance from the sawing piece. Conventionally, this has been complex or impossible to arrange.

In the solution according to the invention, one achieves, by assembling the blade guides into an arm assembly turnable relative to the blade-axle centre, the transfer of the blade guide with a circular-blade unit when moved in the axial direction, but one also enables the adjustment of blade guide according to the size of sawing wood piece guided by a separate control device, such as a servo cylinder or other corresponding actuator. The arm assembly of the blade guide is pivoted concentrically with the drive axle of the saw blade to an end or corresponding of a bearing housing in the drive-motor frame. As the blade guide may be adjusted according to the different sizes of wood pieces, the blade guides may be guided in different situations to the correct distance from the sawing piece, whereby the best possible advantage is gained from the blade guides for supporting the blade in order to the saw blade be as straight as possible and not vibrate or deflect harmfully during sawing. The vibrations and deflections weaken the quality of sawing, and because of this, when using adjustable blade guides, the end-result of sawing (and especially when sawing different sizes of wood pieces) is considerably better compared to using conventional blade guides, and the sawing quality is thus more uniform than earlier. In addition, blade damages are decreased, because the saw blade may be supported so well with the blade guides when sawing different sizes of wood pieces that the blade will not be damaged as a result of great vibrations, deflections or corresponding.

Furthermore, the invention is characterised by what is stated in the appended claims and especially by what is stated in the characterising part of claim 1.

Next, the invention is described in more detail by referring to the accompanying drawings in which

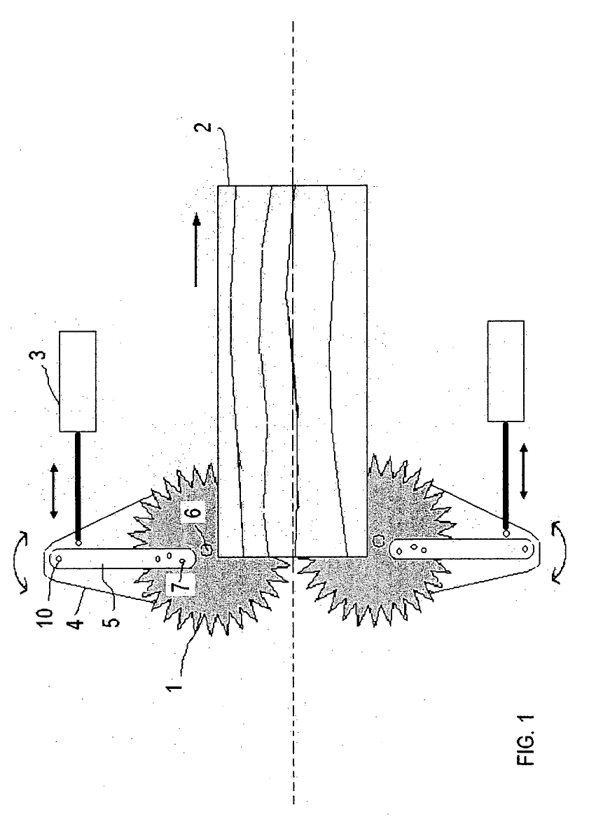

FIG. 1 shows a side view of a circular saw,

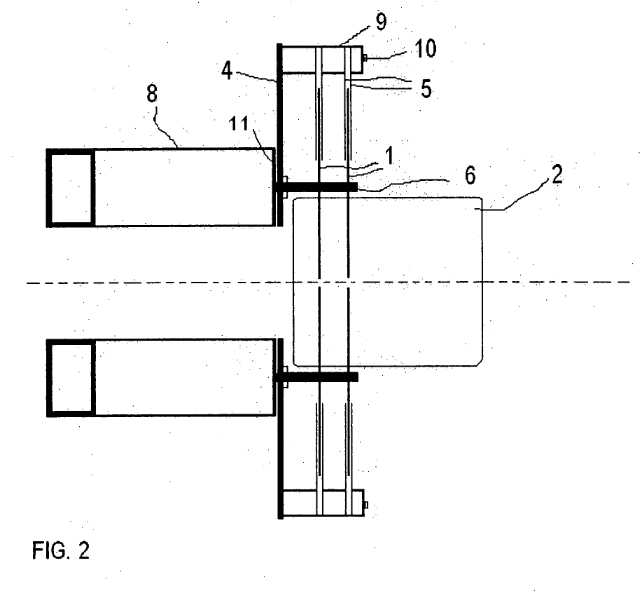

FIG. 2 shows a circular saw (in the sawing direction) seen from the end of the sawn wood piece,

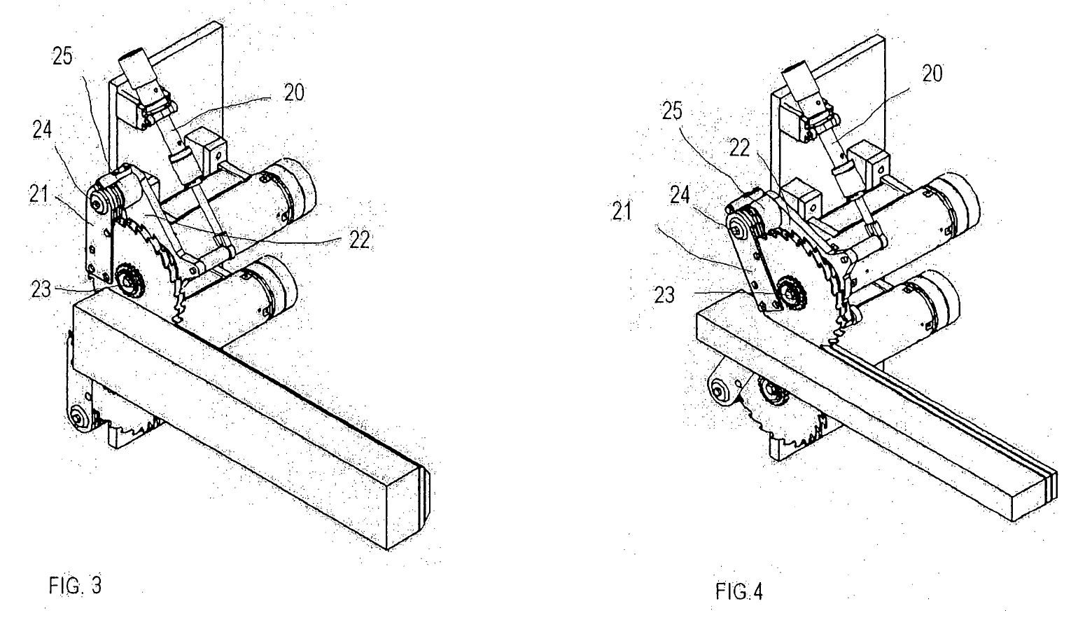

FIGS. 3 and 4 show a circular saw according to the invention in two operating positions.

No numbers have been dedicated to the parts of the lower circular saw of FIGS. 1 and 2, because it is symmetrical with the upper, corresponding circular saw. The lower circular saw may, however, be slightly moved in the sawing direction forwards or backwards in relation to the upper circular saw.

The travel direction of the wood piece is to the right, and the sawing wood piece 2 is passing the blade unit according to FIG. 1. A fastening arm 4 of the blade guide is pivoted concentrically with a blade axle 6, for example, to an end 11 of a bearing housing in a drive-motor 8 of the circular saw. Adjacent saw blades 1 are on their axle 6 in the axial direction, that is, in the direction of a level shown in the figure, freely movable, but as the axle 6 is threaded, they receive a torque through the threading on the axle 6. The threading of axle 6 has not been marked in the figure, but the threading is long enough for the saw blades 1, of which there may be several side by side on the same axle, to receive their torque from the axle 6.

To the fastening arm 4 of the blade guide is fastened an actuator 3, which may be a servo cylinder or corresponding or alternatively, for instance, a screw control, and the actuator or the screw control enables the fastening arm 4 of the blade guide 5 to move around the axle 6, the fastening arm of the blade guide being pivoted concentrically with the fastening arm of the drive axle 6. A fastening bearing 10 of the blade guide moves thus on a subcircular track (part of a circular track) when the actuator moves the fastening arm 4 of the blade guide. The blade guide 5 is thus fastened pivotedly to the fastening arm 4 of the blade guide with the fastening bearing 10 which enables the movement of the blade guide, whereby one may position the blade guide 5, for example, to a vertical direction irrespective of the position of the fastening arm 4 of the blade guide. The blade guide 5 may be positioned to the correct distance from the sawing wood piece 2, whereby as great as possible advantage is gained from it, and harmful deflections and vibrations in the saw blade 1 are prevented.

The blade guide may also have protrusions or corresponding 7 which are in contact with saw blades 1, and thus also guide the saw blades.

A sawing piece, of which the outer parts will be sawn out, is indicated in FIG. 2 with reference number 2. According to the figure, saw blades 1 are controlled with blade guides, which blade guides are fastened so that they are on the both sides of the saw blades 1. The blade guides 5 are fastened pivotedly or in a corresponding manner to a fastening piece 9 which is fastened to the fastening arm assembly 4. The blade guides may be moved to the right or to the left when required, because they are able to move in the fastening piece 9, and the blade guides may be locked to a desired position with a fastening screw or corresponding fastening member 10. When moving the blade guides 5 in the horizontal direction, also the saw blades 1 are able to move in the horizontal direction to the left or to the right, because the drive axle 6 has threading along which the saw blades may move, and the saw blades receive their torque from the threading on the axle (threading not shown in the figure). The fastening arm 4 is fastened pivotedly to the end 11 of the bearing housing in the drive motor. The fastening arm is fastened to the end of the bearing housing in the drive motor so that it is concentric with the drive axle 6.

FIGS. 3 and 4 show a circular saw according to the invention in two operating positions.

FIG. 3 shows a circular saw for sawing wood pieces, which circular saw has blade guides 21 which are fastened to fastening arms 22, and the fastening arm 22 of the blade guides 21 is fastened concentrically with a drive axle 23 of the saw blade pivotedly so that the fastening arm is able to turn around the drive axle, and the blade guides are fastened to the fastening arm 22 pivotedly with a fastening bearing 24 so that they are able to turn around the fastening bearing 24. According to the figure, when sawing, the blade guides are in a vertical position, close enough to the sawing piece supporting the saw blades.

The blade guides 21 may be moved in the axial direction relative to a fastening piece 25.

In FIG. 4, the fastening arm 22 of the blade guide has been turned controlled by an actuator 20, whereby the blade guides 21 may come closer to the sawing piece, giving the best possible support for the saw blades.

It is well known by those skilled in the art that the invention does not limit to the embodiments described above, but it may vary within the scope of the enclosed patent claims.

1. A circular saw for sawing wood pieces, which circular saw has blade guides (5, 21) which are fastened to fastening arms (4, 22), characterised in that the fastening arm (4, 22) of the blade guides (5, 21) is fastened concentrically with a drive axle (6, 23) of the saw blade (1) pivotedly so that the fastening arm is able to turn around the drive axle (6, 23), and the blade guides are fastened to the fastening arm (4, 22) pivotedly with a fastening bearing (10, 24) so that they are able to turn around the fastening bearing (10, 24).

2. A circular saw according to claim 1, characterised in that it has a servo cylinder or other corresponding actuator (3, 20) controlling the movement of the fastening arm (4, 22) of the blade guide.

3. A circular saw according to claim 2, characterised in that the movement of the fastening arm (4, 22) of the blade guide is controlled with a screw control or corresponding.

4. A circular saw according to claim 1, characterised in that the blade guides (5, 21) may be moved in the axial direction relative to a fastening piece (9, 25).

5. A circular saw according to claim 4, characterised in that the blade guides (5, 21) may be locked to a desired position with the fastening bearing (10, 24).
